(19) United States
(12) Patent Application Publication
(10) Pub. No.: US 2014/0300979 A1
(43) Pub. Date: Oct. 9, 2014

(54) HALF MIRROR FRONT PLATE

(71) Applicant: ASAHI GLASS COMPANY, LIMITED, Chiyoda-ku (JP)

(72) Inventors: Michihisa TOMIDA, Chiyoda-ku (JP); Koji SASAKI, (US)

(73) Assignee: ASAHI GLASS COMPANY, LIMITED, Chiyoda-ku (JP)

(21) Appl. No.: 14/245,133

(22) Filed: Apr. 4, 2014

(30) Foreign Application Priority Data
Apr. 5, 2013 (JP) 2013-079200

(51) Int. Cl. G02B 5/08

(52) U.S. Cl. CPC G02B 5/08
USPC 359/839

(57) ABSTRACT

To provide a half mirror front plate which has luminous transmittance and luminous reflectance enough to function as a half mirror for display, provides color tones of transmitted light and reflected light close to neutral (visually white), and is excellent in productivity. A half mirror front plate for display includes a stack consisting of a transparent substrate and a half mirror stacked film arranged on one principal surface of the transparent substrate, wherein the half mirror stacked film has a first transparent oxide layer with a thickness of 45 nm to 70 nm made of a first metal oxide, a metal layer with a thickness of 30 nm to 45 nm mainly made of silver, and a second transparent oxide layer with a thickness of 45 nm to 70 nm made of a second metal oxide in order from the transparent substrate side.

### CROSS-REFERENCE TO RELATED APPLICATIONS

This application is based upon and claims the benefit of priority from the prior Japanese Patent Application No. 2013-079200, filed on Apr. 5, 2013; the entire contents of all of which are incorporated herein by reference.

### FIELD

The present invention relates to a half mirror front plate for display provided on the front surface of a display.

### BACKGROUND

In recent years, a design-conscious display is demanded to become a so-called half mirror which becomes a mirror during the power off and displays an image during the power on. Hence, to cause the display to function as a half mirror, a method of providing a TiO₂ layer on the surface of a glass plate constituting the display by the sputtering is discussed but has not achieved sufficient reflectance.

Further, Patent Reference 1 (JP-A 2011-71973) discloses a method of installing a glass plate having a metal thin film layer provided by the sputtering on the front surface of a display, but this method cannot be said to achieve sufficient transmission and reflection because of large absorption. Further, Patent Reference 2 (JP-A 2008-083262) discloses a method of using a multilayer film made by repeatedly stacking a high-refractive index material and a low-refractive index material. However, the multilayer film has a problem in coloring from the viewpoint of color tone when the number of stacked layers is small, whereas it has a problem in occurrence of stress such as cracks and poor productivity when the number of stacked layers is increased.

### SUMMARY

The present invention has been made from the above viewpoint and its object is to provide a half mirror front plate which has luminous transmittance and luminous reflectance enough to function as a half mirror for display, provides color tones of transmitted light and reflected light close to neutral (visually white), and is excellent in productivity.

A half mirror front plate of the present invention is a half mirror front plate for display including a stack consisting of a transparent substrate and a half mirror stacked film arranged on one principal surface of the transparent substrate, wherein the half mirror stacked film has a first transparent oxide layer with a thickness of 45 nm to 70 nm made of a first metal oxide, a metal layer with a thickness of 30 nm to 45 nm mainly made of silver, and a second transparent oxide layer with a thickness of 45 nm to 70 nm made of a second metal oxide, in order from the transparent substrate side.

The half mirror front plate of the present invention, when installed on the front of a display, sufficiently functions as a mirror during the power off of the display and provides an image rarely different from the image before the installation thereof during the power on. In other words, the half mirror front plate has luminous transmittance and luminous reflectance enough to function as a half mirror for display, provides color tones of transmitted light and reflected light close to neutral (visually white). Further, the half mirror front plate is small in number of stacked layers of a stack for forming the half mirror, and is thus excellent in productivity.

### BRIEF DESCRIPTION OF THE DRAWINGS

FIG. 1 is a cross-sectional view illustrating an example of a display device to which the embodiment of the half mirror front plate of the present invention is applied.

FIG. 2 is a cross-sectional view illustrating another example of a display device to which the embodiment of the half mirror front plate of the present invention is applied.

FIG. 3 is a cross-sectional view illustrating an example of the embodiment of the half mirror front plate of the present invention

FIG. 4 is a cross-sectional view illustrating a modified example of the embodiment of the half mirror front plate of the present invention.

FIG. 5 is a cross-sectional view illustrating a modified example of the embodiment of the half mirror front plate of the present invention.

FIG. 6 is a cross-sectional view illustrating a modified example of the embodiment of the half mirror front plate of the present invention.

FIG. 7 is a cross-sectional view illustrating a modified example of the embodiment of the half mirror front plate of the present invention.

### DETAILED DESCRIPTION

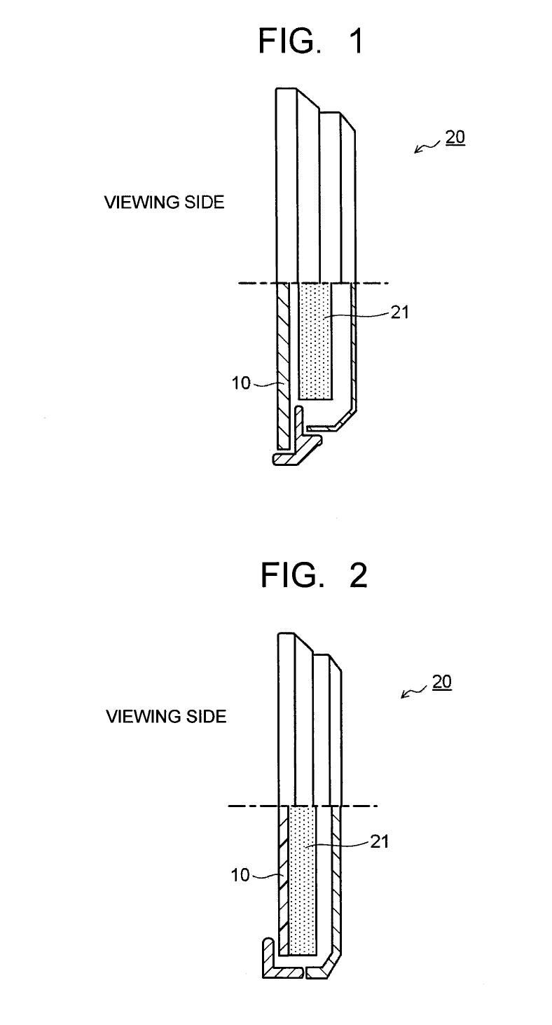

An embodiment of a half mirror front plate of the present invention will be described referring to the drawings. Note that the present invention is not limited to the following embodiment. FIG. 1 and FIG. 2 are cross-sectional views illustrating examples of display devices to which the embodiments of the half mirror front plate of the present invention are applied. FIG. 1 illustrates an example of a display device 20 in which a half mirror front plate 10 is independently arranged on the viewing side at a distance from a display 21, and FIG. 2 illustrates an example of a display device 20 in which the half mirror front plate 10 is directly attached to the front surface of the display 21. Hereinafter, the half mirror front plate is simply called as a “front plate.” Note that the viewing side means the side where a person viewing the display device is present and the opposite side to the viewing side means the display side in this specification.

In this specification, transparent means transmission of 80% or more, on average, of light in a wavelength region of 400 nm to 800 nm. Further, the front plate for display functioning as a half mirror means that the front plate becomes a mirror during the power off of the display and allows an image to be displayed favorably compared with the time when the front plate is not installed during the power on and, more specifically, means that both of the luminous transmittance and the luminous reflectance by a C light source measured according to JIS Z8701 (1999) have high values. Further, unless otherwise noted in this specification, the “luminous transmittance” and the “luminous reflectance” means the luminous transmittance and the luminous reflectance by the C light source measured according to JIS Z8701 (1999) respectively.

The display device 20 and the display 21 to which the front plate 10 of the embodiments of the present invention is applied are not particularly limited. Examples of the display device 20 include AV equipment and communication devices such as a television set, a personal computer, a car navigation system, a video camera, a tablet computer, a mobile phone and so on, and various monitors. Further, examples of the display 21 include a cathode-ray tube display, a liquid crystal display, a plasma display, an organic/inorganic EL display, an FED display and so on.

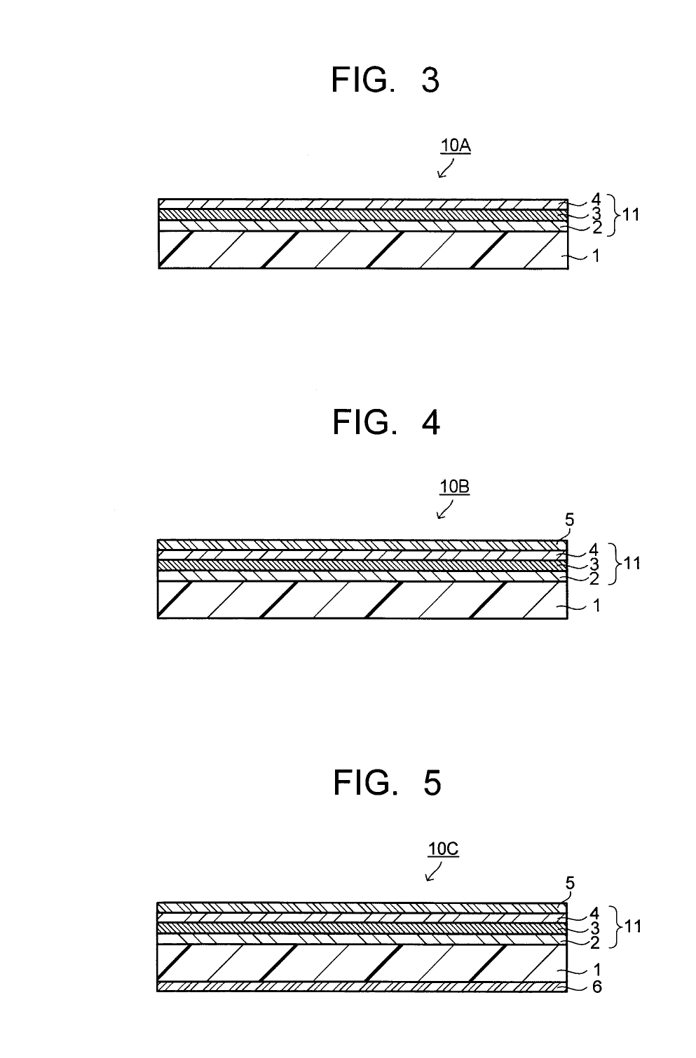

FIG. 3 is a cross-sectional view illustrating an example of the embodiment of the half mirror front plate of the present invention. A front plate 10A illustrated in FIG. 3 is composed of a stack including a transparent substrate 1 and a half mirror stacked film 11 arranged on one principal surface of the transparent substrate 1. In the front plate 10A, the half mirror stacked film 11 is composed of, in order from the transparent substrate 1 side, a first transparent oxide layer 2 with a thickness of 45 nm to 70 nm made of a first metal oxide, a metal layer 3 with a thickness of 30 nm to 45 nm mainly made of silver, and a second transparent oxide layer 4 with a thickness of 45 nm to 70 nm made of a second metal oxide.

The transparent substrate 1 is a substrate having transparency and having a mechanical strength withstanding the load received when the half mirror stacked film 11 is formed. Examples of the material constituting the transparent substrate 1 include glass and resin. Concrete examples of the resin include polyesters such as polyethylene terephthalate (PET), polybutylene terephthalate, and polyethylene naphthalate, polyacrylates such as polymethyl methacrylate (PMMA) and so on, polycarbonate (PC), polystyrene, cycloolefin polymer (COP), triacetylcellulose (TAC), polyvinyl alcohol, polyvinyl chloride, polyvinylidene chloride, polyethylene, ethylene-vinyl acetate copolymer, polyvinyl butyral, metal ion crosslinked ethylene/methacrylic acid copolymer, polyurethane, cellophane and so on. As the resin, polyester, PC, COP, TAC are particularly preferable.

Note that the material constituting the transparent substrate 1 is appropriately selected according to the kind or usage of the display. In the case of the liquid crystal display, a material with low birefringent index, for example, COP or TAC is particularly preferable. Further, a material produced by a stretching method, such as a PET film, is preferable because it is relatively high in strength and can suppress occurrence of defects such as break during manufacture and machining.

The thickness of the transparent substrate 1 is not necessarily limited. In the case where the front plate 10A is used as the front plate arranged independently from the display as in FIG. 1, the transparent substrate 1 is preferably made of glass or resin and has a thickness of 0.1 mm to 5.0 mm. Further, in the case where the front plate 10A is used attached to the display as in FIG. 2, the transparent substrate 1 is preferably made of resin and has a thickness of 5 μm to 200 μm. It is preferable to set the thickness to 5 μm or more because occurrence of defects such as break during manufacture and machining of the transparent substrate 1 can be suppressed. It is also preferable to set the thickness to 200 μm or less because the whole thickness of the front plate 10A can be suppressed. The thickness of the transparent substrate 1 in this case is preferably 30 μm to 150 μm, and more preferably 40 μm to 110 μm.

The half mirror stacked film 11 is provided for the front plate 10A to function as a half mirror, and is composed of, in order from the transparent substrate 1 side, the first transparent oxide layer 2 with a thickness of 45 nm to 70 nm made of the first metal oxide, the metal layer 3 with a thickness of 30 nm to 45 nm mainly made of silver, and the second transparent oxide layer 4 with a thickness of 45 nm to 70 nm made of the second metal oxide.

The first transparent oxide layer 2 and the second transparent oxide layer 4 (hereinafter, they are sometimes collectively referred to simply as transparent oxide layers 2, 4) are composed of the first metal oxide and the second metal oxide respectively. Each of the first metal oxide and the second metal oxide preferably has, as a main component, a zinc oxide containing zinc as a main oxide constituent metal.

Here, the first metal oxide and the second metal oxide having a zinc oxide as a main component means that the proportion of the zinc oxide to 100 mass % of metal oxide is more than 50 mass % and equal to or less than 100 mass %.

Further, the zinc oxide containing zinc as a main oxide constituent metal refers to a metal oxide having a proportion of zinc to 100 atom % of the oxide constituent metals of more than 50 atom % and equal to or less than 100 atom %, among metal oxides containing an oxide of zinc only (zinc oxide) and composite oxides containing zinc and metal elements other than zinc. The proportion of zinc to 100 atom % of the oxide constituent metals in the zinc oxide is preferably 75 atom % or more, and more preferably 85 atom % or more.

Preferable examples of the metal elements other than zinc of the oxide constituent metals in the zinc oxide include tin, aluminum, chromium, titanium, magnesium, and gallium, and only one or two or more of them may be used. Among them, at least one selected from aluminum, titanium, and gallium is particularly preferable. Use of a zinc oxide containing at least one selected from aluminum, titanium, and gallium as the oxide constituent metals other than zinc makes it possible, for example, when forming the transparent oxide layers 2, 4, to make their compatibility with the metal layer 3 in contact with them excellent and to effectively decrease the internal stress so as to increase their adhesion to the metal layer 3, resulting in excellent stability and durability.

In the case where the metal elements other than zinc are aluminum and/or gallium, the proportion of aluminum and/or gallium to 100 atom % of the oxide constituent metals of the zinc oxide is preferably 1 atom % to 15 atom %. Setting the proportion of aluminum and/or gallium to 1 atom % or more, for example, makes it possible to effectively decrease the internal stress of the transparent oxide layers 2, 4 so as to increase their adhesion to the metal layer 3, thereby making the stability and durability excellent. Further, setting the proportion of aluminum and/or gallium to 15 atom % or less, for example, makes it possible to keep the crystallinity of the transparent oxide layers 2, 4 to thereby maintain the compatibility with the metal layer 3, resulting in excellent moisture resistance and so on. The proportion of aluminum and/or gallium to 100 atom % of the oxide constituent metals in the zinc oxide is more preferably 1.5 atom % to 10 atom %, and particularly preferably 1.5 atom % to 8.0 atom %.

In the case where the element other than zinc is titanium, the proportion of titanium to 100 atom % of the oxide constituent metals in the zinc oxide is preferably 2 atom % to 20 atom %. Setting the proportion of titanium to 2 atom % or more, for example, makes it possible to effectively decrease the internal stress of the transparent oxide layers 2, 4 so as to increase their adhesion to the metal layer 3, thereby making the stability and durability excellent. Further, setting the proportion of titanium to 20 atom % or less, for example, makes it possible to keep the crystallinity of the transparent oxide layers 2, 4 to thereby maintain the compatibility with the metal layer 3, resulting in excellent moisture resistance and so on. The proportion of titanium to 100 atom % of the oxide constituent metals in the zinc oxide is more preferably 3 atom % to 15 atom %.

The transparent oxide layers 2, 4 become excellent, for example, in compatibility with the metal layer 3 because of the crystallinity and so on of the first metal oxide and the second metal oxide being their constituent materials and thereby can make the stability and durability of the metal layer 3 excellent. Note that the first metal oxide and the second metal oxide may have different compositions from each other but preferably have the same composition.

The first metal oxide and the second metal oxide constituting the first transparent oxide layer 2 and the second transparent oxide layer 4 respectively preferably have a refractive index of 1.7 to 2.3, more preferably 1.8 to 2.2, and further preferably 1.9 to 2.1. Setting the refractive index of the first metal oxide and the second metal oxide to the above-described range makes it possible to increase both the luminous transmittance and the luminous reflectance by the interference effect between the first transparent oxide layer 2 and the second transparent oxide layer 4 and the metal layer 3 sandwiched therebetween. Note that the refractive index means the refractive index in a wavelength of 555 nm in this specification.

The film thickness (physical film thickness, the same applies hereinafter) of each of the first transparent oxide layer 2 and the second transparent oxide layer 4 is 45 nm to 70 nm. The film thicknesses of the first transparent oxide layer 2 and the second transparent oxide layer 4 may be the same or different as long as they are within the above-described range. Setting the film thicknesses of the first transparent oxide layer 2 and the second transparent oxide layer 4 within the above-described range makes it possible to increase both the luminous transmittance and the luminous reflectance by the interference effect between the first transparent oxide layer 2 and the second transparent oxide layer 4 and the metal layer 3 sandwiched therebetween. The film thickness of each of the first transparent oxide layer 2 and the second transparent oxide layer 4 is preferably 50 nm to 65 nm.

The film thicknesses of the first transparent oxide layer 2 and the second transparent oxide layer 4 can be actually measured by electron microscope observation or the like of their cross sections. Note that the film thickness may be found from optical characteristics of each layer by an ordinary method. Further, the first transparent oxide layer 2 and the second transparent oxide layer 4, including the metal layer 3 described below, are generally formed by the sputtering method as will be described later. In this case, the film thickness of each layer may be found by an ordinary method from the sputtering deposition rate and the sputtering time. Any of the method of finding the film thickness from the optical characteristics and the method of finding the film thickness from the sputtering deposition rate and the sputtering time is the method which can sufficiently reproduce the actual measurement value.

In the half mirror stacked film 11, the metal layer 3 existing sandwiched between the first transparent oxide layer 2 and the second transparent oxide layer 4 is a layer composed of a metal material mainly made of silver. Here, “mainly made of silver” means that the metal material contains silver at a proportion of more than 50 mass % and equal to or less than 100 mass % to the total mass of the metals constituting the metal layer 3. The constituent metal material of the metal layer 3 is preferably pure silver, namely, 100% of silver from the viewpoint of optical characteristics. However, as the metal layer 3, a layer made of a silver alloy containing at least one kind of metal selected from among palladium and gold in consideration of stability and durability in addition to the optical characteristics. The content of palladium and/or gold in the constituent metal material of the metal layer 3 to the total mass of the constituent metals is preferably 0.2 mass % to 10 mass %, and more preferably 0.2 mass % to 5 mass %. Setting the content of palladium and/or gold within the above-described range, for example, makes it possible to suppress diffusion of silver and thereby increase the moisture resistance and suppress absorption of light.

The thickness of the metal layer 3 is 30 nm to 45 nm. Setting the thicknesses of the first transparent oxide layer 2 and the second transparent oxide layer 4 within the above-described range and setting the thickness of the metal layer 3 within the above-described range makes it possible to increase both the luminous transmittance and the luminous reflectance by the interference effect among these three layers. The thickness of the metal layer 3 is preferably 35 nm to 45 nm.

Examples of the method of forming the half mirror stacked film 11 on one principal surface of the transparent substrate 1 in the front plate 10A illustrated in FIG. 3, namely, forming, in order from the transparent substrate 1 side, the first transparent oxide layer 2, the metal layer 3, and the second transparent oxide layer 4 include conventionally known methods such as the sputtering method, the vacuum deposition method, the ion plating method, the chemical vapor deposition method and so on.

The formation of the half mirror stacked film 11 is preferably performed, in particular, by the sputtering method because of excellent stability in quality and characteristics. Examples of the sputtering method include the DC sputtering method, the AC sputtering method, the high-frequency sputtering method and so on. The formation of the half mirror stacked film 11 by the sputtering method can be performed as follows for instance.

A case where as the constitution of the half mirror stacked film 11, both of the first metal oxide and the second metal oxide constituting the first transparent oxide layer 2 and the second transparent oxide layer 4 respectively are zinc oxides composed of oxides of zinc and titanium, and the metal constituting the metal layer 3 is a silver alloy will be described as an example. Note that the formation also applies to the case where the constituent materials of the layers are different from the above.

First, while introducing argon gas mixed with oxygen gas, the DC sputtering is performed on the surface of the transparent substrate 1 using a mixed target made of oxides of zinc and titanium to form the first transparent oxide layer 2. Then, while introducing argon gas, the DC sputtering is performed using a silver alloy target to form the metal layer 3. Further, the second transparent oxide layer 4 is formed on the metal layer 3 in the similar manner to the formation of the first transparent oxide layer 2, whereby the half mirror stacked film 11 can be formed on the transparent substrate 1.

The thicknesses of the first transparent oxide layer 2, the metal layer 3, and the second transparent oxide layer 4 can be adjusted by the power density and the sputtering time of the DC sputtering performed when forming the respective layers. Further, the mixed target can be manufactured by mixing high-purity (generally 99.9%) powders of individual oxides of metals, in particular, high-purity zinc oxide powder and high-purity titanium oxide powder at a predetermined ratio, and molding the mixture of zinc oxide powder and titanium oxide powder using a cold isostatic press or the like, and then burning it. Note that also in the case where the constituent materials of the layers are different from the above, the half mirror stacked film 11 can be formed on the transparent substrate 1 in the similar manner as the above except that the target to be used is appropriately selected.

Here, it is conceivable to make the constitution of the half mirror stacked film 11 composed of five-layer constitution by adding each of the metal layer and the transparent oxide layer to the above-described three layer constitution, or seven-layer constitution by further adding each of the metal layer and the transparent oxide layer, but it is not practical because the decrease in productivity is large despite a small increase in performance of the half mirror function.

The half mirror stacked film 11 preferably has a surface resistance value of 1 Ω/sq to 10 Ω/sq. The half mirror stacked film 11 having such surface resistance value becomes excellent in electromagnetic wave shielding effect and thereby can effectively suppress malfunction of an electronic device, as an electromagnetic wave shield film.

The front plate 10A illustrated in FIG. 3 is composed of the stack having the half mirror stacked film 11 formed on the transparent substrate 1. The stack can be made to have a luminous transmittance within a range of 30% to 50% and a luminous reflectance within a range of 40% to 60%. As described above, the front plate 10A composed of the above-described stack can be said to be a front plate excellent in half mirror function capable of making both the luminous transmittance and the luminous reflectance high levels. Further, the luminous transmittance is more preferably 32% to 47%, and the luminous reflectance is more preferably 45% to 60%.

Here, in the case where the front plate 10A is used such that the transparent substrate 1 side is the viewing side when it is attached to the display, the luminous transmittance and the luminous reflectance only need to be within the above-described ranges as values measured by irradiation from the C light source from the transparent substrate 1 side. Alternatively, in the case where the front plate 10A is used such that the half mirror stacked film 11 side is the viewing side, the luminous transmittance and the luminous reflectance only need to be within the above-described ranges as values measured by irradiation from the C light source from the half mirror stacked film 11 side. In other words, in the front plate 10A, both the luminous transmittance and the luminous reflectance measured on both principal surfaces do not always need to be within the above-described ranges, but the luminous transmittance and the luminous reflectance measured by irradiation from the C light source from the principal surface on the viewing side in its use only need to be within the above-described ranges. This also applies to the front plate in any of aspects described below.

Further, the stack can be made to have chromatic coordinates (x, y) in an XYZ color system in a 2-degree visual field defined in JIS Z 8722 (2009) of the reflected light obtained from light incident from the C light source, within a range of (0.270≦x≦0.310, 0.270≦y≦0.310). Further, the stack can be made to have chromatic coordinates (x, y) in the XYZ color system in the 2-degree visual field defined in JIS Z 8722 (2009) of the similarly obtained transmitted light, within a range of (0.335≦x≦0.355, 0.350≦y≦0.370). As described above, the front plate 10A composed of the stack can be made to have a transmission color tone and a reflection color tone which are color tones close to neutral (visually white).

In the stack, the color tones of the reflected light and the transmitted light are color tones which can be said to be visually colorless neutral as long as the chromatic coordinates (x, y) of the reflected light and the transmitted light fall within the above-described ranges. The chromatic coordinates (x, y) in the XYZ color system of the transmitted light is more preferably within a range of (0.340≦x≦0.350, 0.355≦y≦0.365), and the chromatic coordinates (x, y) in the XYZ color system of the reflected light is more preferably within a range of (0.280≦x≦0.300, 0.280≦y≦0.300). Note that for the measurement of chromatic coordinates (x, y) of the reflected light and the transmitted light of the stack, the principal surface which is irradiated by the C light source is the same as in the case of the above-described measurement of the luminous transmittance and the luminous reflectance.

The front plate 10A illustrated in FIG. 3 may be used with the half mirror stacked film 11 surface as the viewing side or with the surface of the transparent substrate 1 opposite to the surface on which the half mirror stacked film 11 is provided as the viewing side. In particular, in the case where the front plate 10A is used with the half mirror stacked film 11 surface as the viewing side, it is preferable that a protective layer 5 is provided on the half mirror stacked film 11 as illustrated in FIG. 4. Note that the protective layer 5 may be provided also in the case where the front plate 10A is used with the half mirror stacked film 11 surface as the display side. FIG. 4 is a cross-sectional view illustrating a modified example of the embodiment of the half mirror front plate of the present invention. A front plate 10B illustrated in FIG. 4 has all the same constitution as that of the front plate 10A illustrated in FIG. 3 except that the protection layer 5 is provided on the half mirror stacked film 11.

The protective layer 5 plays a role in protecting the half mirror stacked film 11 from moisture and so on. Further, when an adhesive layer is provided on the half mirror stacked film 11, the protective layer 5 provided between them has a function of improving the adhesion between the half mirror stacked film 11 and the adhesive layer. Here, the adhesive layer is a layer preferably provided on the front plate of a type directly attached to the display 21 illustrated in FIG. 2 as will be described later. Further, the adhesive layer is a layer in the case where a glass plate and the like are further provided even for the front plate that is independent from the display 21 illustrated in FIG. 1.

Examples of the protective layer 5 include a layer composed of an oxide or a nitride of metals such as tin, indium, titanium, silicon, gallium and so on, a layer containing hydrogenated carbon as a main component and so on. As the protective layer 5, a layer composed of oxides of metals such as indium, tin, and gallium or a layer containing hydrogenated carbon as a main component is particularly preferable. The protective layer 5 containing a tin oxide and/or an indium oxide as a main component is particularly preferable.

The film thickness of the protective layer 5 is preferably 2 nm to 30 nm, more preferably 3 nm to 20 nm, and further preferably 3 nm to 10 nm. Setting the film thickness of the protective layer 5 within the above-described range makes it possible to effectively protect the half mirror stacked film 11 from moisture and the like, and providing the adhesive layer further on the protective layer 5 makes it possible to improve the adhesion between the half mirror stacked film 11 and the adhesive layer.

The front plate 10A illustrated in FIG. 3 may be used, as described above, with the half mirror stacked film 11 surface as the viewing side, or with the surface of the transparent substrate 1 opposite to the surface on which the half mirror stacked film 11 is provided as the viewing side. In the case where the surface of the transparent substrate 1 opposite to the surface on which the half mirror stacked film 11 is provided is the viewing side and the transparent substrate 1 is made of resin, it is preferable that a hard coat layer 6 is provided on the surface of the transparent substrate 1 opposite to the surface on which the half mirror stacked film 11 is provided as illustrated in FIG. 5. If the transparent substrate 1 is made of glass or if the half mirror stacked film 11 surface or the protective layer 5 surface, when provided, is used as the viewing side, the hard coat layer is usually not formed.

FIG. 5 is a cross-sectional view illustrating a modified example of the embodiment of the half mirror front plate of the present invention. A front plate 10C illustrated in FIG. 5 has all the same constitution as that of the front plate 10B illustrated in FIG. 4 except that the hard coat layer 6 is provided on the surface of the transparent substrate 1 opposite to the surface on which the half mirror stacked film 11 is provided.

The hard coat layer 6 has a hardness higher than that of the resin constituting the transparent substrate 1 and has a function of suppressing occurrence of small abrasions or the like on the surface of the transparent substrate 1 and suppressing contraction of the transparent substrate 1 made of resin.

The hardness of the hard coat layer 6 preferably is H or higher in pencil hardness, and more preferably 2H or higher. Setting the hardness to H or higher in pencil hardness makes it possible to effectively suppress abrasions and the like on the transparent substrate 1 made of resin. On the other hand, a hardness at about 3H in pencil hardness is enough to suppress abrasions and the like and also suppress occurrence of cracks and the like caused by the hard coat layer 6 becoming too hard. Note that the pencil hardness of the hard coat layer 6 in this specification refers to the hardness measured about the hard coat layer 6 formed on the transparent substrate 1, with a load of 100 g according to JIS K 5400 (1990).

The thickness of the hard coat layer 6 is preferably 0.5 μm to 20 μm, and more preferably 1 μm to 10 μm. Setting the thickness of the hard coat layer 6 to 0.5 μm or more makes it possible to effectively suppress abrasions, contraction and the like in the transparent substrate 1 made of resin. On the other hand, a thickness of about 20 μm of the hard coat layer 6 can sufficiently suppress abrasions, contraction and the like in the transparent substrate 1 made of resin and also suppress occurrence of cracks and the like caused by the hard coat layer 6 becoming too hard.

The hard coat layer 6 is, for example, made of a curable resin that cures by crosslinking due to the action of the resin itself or by a curing agent or the like. Concrete examples of the curable resin include independently curable type of thermo-/ultraviolet-/electron beam-curable resins such as a urethane-based resin, an aminoplast-based resin, a silicone-based resin, an epoxy-based resin, an acryl-based resin and so on, and thermosetting resins cured with a curing agent, such as a polyester-based resin, an acryl-based resin, an epoxy-based resin and so on. Among these, the acryl-based resin is a preferable one because it can easily form an excellent hard coat layer 6.

For the front plate having the hard coat layer 6 on the surface of the transparent substrate 1 opposite to the surface on which the half mirror stacked film 11 is provided as illustrated in FIG. 5, it is preferable to prepare the transparent substrate 1 made of resin with the hard coat layer 6 formed on its one principal surface by applying and curing the thermosetting resin or the like, and form the half mirror stacked film 11 on the principal surface on which the hard coat layer 6 of the transparent substrate 1 is not formed in the above-described manner.

Functions such as antistatic, slipperiness, fingerprint removability, antireflection functions may be added as necessary to the hard coat layer 6.

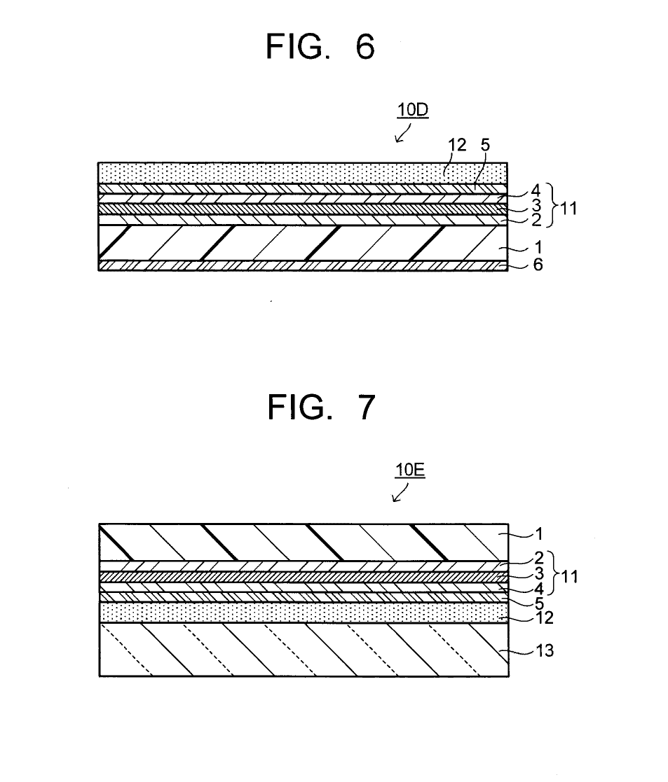

FIG. 6 is a cross-sectional view illustrating another modified example of the embodiment of the front plate of the present invention. A front plate 10D illustrated in FIG. 6 is a front plate with a constitution having an adhesive layer 12 on the protective layer 5 of the front plate 10C illustrated in FIG. 5. Here, the protective layer 5 and the hard coat layer 6 are layers arbitrarily provided in the front plate 10D. The protective layer 5 is preferably provided because it has the function of improving the adhesion between the adhesive layer 12 and the half mirror stacked film 11 as described above. Further, the hard coat layer 6 is preferably provided because it suppresses abrasions on the surface, contraction and so on of the transparent substrate 1 made of resin. The front plate 10D having the adhesive layer 12 can be directly attached to the display via the adhesive layer 12, and is thus excellent in workability as compared, for example, with the case where the front plate is attached to the display using an adhesive or the like. The components other than the adhesive layer 12 in the front plate 10D can be all the same as those of the front plate 10C.

Examples of the adhesive layer 12 include the one made of only an adhesive or those containing various functional additives such as an ultraviolet absorbent and the like in an adhesive. Examples of the adhesive include an acryl-based adhesive, a silicone-based adhesive, a urethane-based adhesive, and a butadiene-based adhesive, and among these, the acryl-based adhesive is preferably used. The acryl-based adhesive is a polymer containing an acryl-based monomeric unit as a main component. Examples of the acryl-based monomeric unit include a (metha) acrylic acid, an itaconic acid, an (anhydrous) maleic acid, an (anhydrous) fumaric acid, a crotonic acid, and their alkyl esters. Here, the (metha) acrylic acid is used as the generic name of an acrylic acid and a methacrylic acid.

The thickness of the adhesive layer 12 is preferably 10 μm to 50 μm, and more preferably 20 μm to 30 μm. Setting the thickness of the adhesive layer 12 to the above-described range makes it possible to secure sufficient adhesiveness without affecting the half mirror function as the front plate.

Further, a front plate may be formed by further stacking a glass plate on the adhesive layer 12 of the stack with the constitution having the protective layer 5 and the adhesive layer 12 on the half mirror stacked film 11 formed on the transparent substrate 1. The cross-sectional view of a front plate 10E of the embodiment of the present invention having the above-described constitution is illustrated in FIG. 7. The front plate 10E has the same constitution as that of the front plate 10D illustrated in FIG. 6 except that a glass plate 13 is provided but the hard coat layer 6 is not provided. The front plate 10E has a constitution with the glass plate 13 side as the viewing side and therefor does not have the hard coat layer 6 on the surface of the transparent substrate 1 opposite to the surface on which the half mirror stacked film 11 is provided. For example, if the hard coat layer 6 is provided on the surface of the transparent substrate 1 opposite to the surface on which the half mirror stacked film 11 is provided, the front plate 10E having abrasion resistance can cope also with the use with the hard coat layer 6 side as the viewing side.

The glass plate 13 is not particularly limited in kind as long as it is a transparent glass. The thickness of the glass plate 13 can be arbitrarily selected depending on the usage but is preferably 0.5 mm to 20 mm for self-standing property as the front plate, and more preferably 0.7 mm to 5 mm from the viewpoint of achieving sufficient strength and not increasing the weight of the front plate.

For example, for the front plate of the embodiment of the present invention with the constitution in which the glass plate 13 and the transparent substrate 1 holds the half mirror stacked film 11 therebetween as in the front plate 10E whose cross section is illustrated in FIG. 7, the luminous transmittance can be set within a range of 25% to 50% and the luminous reflectance can be set within a range of 45% to 65%. The front plate can be said to be a front plate excellent in half mirror function which can make both the luminous transmittance and the luminous reflectance high levels. The half mirror function in the front plate more preferably has a luminous transmittance within a range of 30% to 40% and a luminous reflectance within a range of 50% to 65%. Note that in the front plate of the embodiment of the present invention with the constitution in which the glass plate 13 and the transparent substrate 1 holds the half mirror stacked film 11 therebetween, the protective layer 5 and the hard coat layer 6 are arbitrary components.

Here, in the case where the front plate 10E is used such that the transparent substrate 1 side is the viewing side when the front plate 10E is attached to the display, the luminous transmittance and the luminous reflectance only need to be within the above-described ranges as values measured by irradiation from the C light source from the transparent substrate 1 side. Alternatively, in the case where the front plate 10E is used such that the glass plate 13 side is the viewing side, the luminous transmittance and the luminous reflectance only need to be within the above-described ranges as values measured by irradiation from the C light source from the glass plate 13 side.

Further, the front plate of the embodiment of the present invention with the constitution in which the glass plate 13 and the transparent substrate 1 holds the half mirror stacked film 11 therebetween can be made to have chromatic coordinates (x, y) in the XYZ color system in the 2-degree visual field defined in JIS Z 8722 (2009) of the reflected light obtained from light incident from the C light source, within a range of (0.300≦x≦0.325, 0.300≦y≦0.325). Further, the front plate can be made to have chromatic coordinates (x, y) in the XYZ color system in the 2-degree visual field defined in JIS Z 8722 (2009) of the similarly obtained transmitted light, within a range of (0.300≦x≦0.325, 0.325≦y≦0.345). In other words, the front plate with the above constitution can be made to have a transmission color tone and a reflection color tone which are color tones close to neutral (visually white).

The chromatic coordinates (x, y) in the XYZ color system are more preferably (0.305≦x, y≦0.320) for the reflected light and (0.305≦x≦0.320, 0.330≦y≦0.340) for the transmitted light. Note that for the measurement of chromatic coordinates (x, y) of the reflected light and the transmitted light in the front plate of the embodiment of the present invention with the constitution in which the glass plate 13 and the transparent substrate 1 holds the half mirror stacked film 11 therebetween, the principal surface which is irradiated by the C light source is the same as in the case of the above-described measurement of the luminous transmittance and the luminous reflectance.

Decoration may be applied to the glass plate 13. Examples of the decoration include use of a pattern black-painted like a frame at a peripheral portion of the display for hiding wiring and so on existing at the peripheral portion and the like. The decoration may be applied to the display side of the glass plate 13 or to the viewing side, and it is more preferable to apply the decoration to the display side because a step caused by its printing is invisible. The decoration existing closer to the viewing side than the half mirror stacked film 11 enables expression in a desired color. Note that even if the decoration is applied closer to the display side than the half mirror stacked film 11, it is possible to hide the wiring and so on although its color changes due to the half mirror function, and therefore a designer can arbitrarily select a decoration position. Similarly, decoration may be applied to the transparent substrate 1.

As the method of decoration, various printing methods can be used depending on the pattern desired to be expressed, and the screen printing, the gravure printing, the gravure offset printing, the flexographic printing, the ink jet printing and so on are preferably used.

The embodiment of the present invention has been described using the front plates 10A to 10E illustrated in FIG. 3 to FIG. 7 as examples, but the front plate of the present invention is not limited to them. The constitution may be arbitrarily changed without departing from the scope of the present invention and as necessary.

### EXAMPLES

The present invention will be concretely described below using Examples, but the present invention is not limited by these examples. Note that the film thickness in Example is a value obtained from the optical characteristics or the sputtering deposition rate and the sputtering time and not the actually measured film thickness. The characteristics in each Example were measured as follows. The examples 1 to 3 are Examples and the examples 4, 5 are Comparative Examples. In each of the following examples, a front plate 10E′ having the hard coat layer 6 on the surface of the transparent substrate 1 opposite to the surface on which the half mirror stacked film 11 was provided in the front plate 10E whose cross section is illustrated in FIG. 7 was manufactured.

### Example 1

First, dry cleaning with ion beams was performed in order to clean the surface, of a PET film 1 with the hard coat layer 6 formed thereon (thickness: PET; 100 μm, hard coat layer; 2 μm), on which the hard coat layer 6 was not formed (the surface on which the half mirror stacked film 11 was to be formed). This dry cleaning was carried out by applying electric power of 100 W while introducing mixed gas made by mixing about 30% of oxygen into argon gas and applying argon ions and oxygen ions ionized by an ion beam source.

Then, the AC magnetron sputtering was performed on the aforementioned formation surface at a pressure of 0.1 Pa, by using a target obtained by mixing and burning a zinc oxide and a titanium oxide (zinc oxide:titanium oxide=90:10 (mass ratio)) while introducing 10 vol % of oxygen mixed into argon gas, and adjusting the power density and the sputtering time to form an oxide film of zinc oxide and titanium oxide with a thickness of 62 nm (refractive index of 2.02, the first transparent oxide layer 2, composition abbreviated expression: TZO).

The DC magnetron sputtering with a frequency of 100 kHz and a reverse pulse width of 5 μsec was performed on the first transparent oxide layer 2 at a pressure of 0.3 Pa by using a silver alloy target doped with 1.0 mass % of gold while introducing argon gas, and adjusting the power density and the sputtering time to form a metal film (metal layer 3) with a thickness of 35 nm.

Then, the AC magnetron sputtering was performed on the aforementioned metal layer 3 at a pressure of 0.1 Pa, by using a target obtained by mixing and burning a zinc oxide and a titanium oxide (zinc oxide:titanium oxide=90:10 (mass ratio)) while introducing 10 vol % of oxygen gas mixed into argon gas, and adjusting the power density and the sputtering time to form an oxide film of zinc oxide and titanium oxide with a thickness of 62 nm (refractive index of 2.02, the second transparent oxide layer 4, composition abbreviated expression: TZO). Thus, a PET film stack having the half mirror stacked film 11 composed of the first transparent oxide layer 2, the metal layer 3, and the second transparent oxide layer 4 on the surface, of the PET film 1 having the hard coat layer 6, opposite to the hard coat layer 6 was obtained.

Further, the DC magnetron sputtering with a frequency of 100 kHz and a reverse pulse width of 1 μsec was performed on the half mirror stacked film 11 (second transparent oxide layer 4) of the PET film stack at a pressure of 0.1 Pa, by using an oxide target of indium oxide and tin oxide (ITO target (indium oxide:tin oxide=90:10 (mass ratio))) while introducing a mixed gas made by mixing 7 vol % of oxygen gas into argon gas, and adjusting the power density and the sputtering time to form a protective layer 5 with a thickness of 5 nm (refractive index of 2.08). Furthermore, an adhesive film containing the ultraviolet absorbent was attached, as the adhesive layer 12 (thickness; 20 μm), on the protective layer 5 to obtain a PET film stack with adhesive layer having the same cross section as that illustrated in FIG. 6.

The obtained PET film stack with adhesive layer was cut into a size of 50 mm×50 mm and uniformly attached, via the adhesive layer 12, to a soda-lime glass plate 13 with a size of 50 mm×50 mm and a thickness of 2 mm without entrance of air bubbles to thereby manufacture the front plate 10E′.

(Measurement of Luminous Transmittance (Tv) and Luminous Reflectance (Rv))

About the obtained front plate 10E′, the luminous transmittance (Tv) and the luminous reflectance (Rv) by the C light source were measured using a TC-1800 spectroscopic color difference meter manufactured by Tokyo Denshoku Co., Ltd. according to JIS Z8701 (1999). Note that the luminous transmittance (Tv) was measured in the case where light from the C light source was made incident on the hard coat layer (HC layer) 6 side. The luminous reflectance (Rv) was measured in both the case where light from the C light source was made incident on the hard coat layer (HC layer) 6 side and the case where light from the C light source was made incident on the glass plate 13 side. Here, the luminous transmittance (Tv) was measured only in the case where light from the C light source was made incident on the hard coat layer 6 side because there is no difference between the case where light from the C light source was made incident on the hard coat layer 6 side and the case where light from the C light source was made incident on the glass plate 13 side.

In addition, the chromatic coordinates (x, y) in the XYZ color system in the 2-degree visual field defined in JIS Z 8722 (2009) of the reflected light obtained from the light incident from the C light source were measured about both the case where the light from the C light source was made incident on the hard coat layer 6 side and the case where the light from the C light source was made incident on the glass plate 13 side by the TC-1800 spectroscopic color difference meter. Further, the chromatic coordinates (x, y) in the XYZ color system in the 2-degree visual field defined in JIS Z 8722 (2009) of the transmitted light in the case where the light from the C light source was made incident on the hard coat layer 6 side were measured by the TC-1800 spectroscopic color difference meter.

About the PET film stack obtained in the above, the luminous transmittance (Tv), the luminous reflectance (Rv), and the chromatic coordinates (x, y) in the XYZ color system of the transmitted light and the reflected light were similarly measured in the case where the light from the C light source was made incident on the half mirror stacked film 11 side. The results are illustrated in Tale 1.

(Measurement of Sheet Resistance Value)

The PET film stack obtained in the above was cut into a size of 100 mm×100 mm and its sheet resistance value (surface resistance value) was measured using an eddy current type resistance measuring device (trade name: SRM12) manufactured by Nagy Co., Ltd. The measurement results are illustrated in Table 1.

### Example 2 to Example 5

Front plates in Example 2 to Example 5 were produced in the similar manner to Example 1 except that the thickness of the metal layer 3 was changed as illustrated in Table 1, and evaluated similarly to Example 1. The results are illustrated in Table 1.

TABLE 1

| | | | | E1 | E2 | E3 | E4 | E5 |
|---|---|---|---|---|---|---|---|---|
| Thickness of | First transparent | TZO | | 62 | 62 | 62 | 62 | 62 |
| each layer | oxide layer 2 | | | | | | | |
| [nm] | Metal layer 3 | Silver alloy | | 35 | 38 | 41 | 28 | 48 |
| | Second transparent | TZO | | 62 | 62 | 62 | 62 | 62 |
| | oxide layer 4 | | | | | | | |
| Half mirror | Front plate | Luminous transmittance (%) | | 40.0 | 32.9 | 30.1 | 52.1 | 21.8 |
| function | | (HC layer side) | | | | | | |
| | | Luminous reflectance (%) | | 52.7 | 59.4 | 61.7 | 41.9 | 69.9 |
| | | (HC layer side) | | | | | | |
| | | Luminous reflectance (%) | | 51.8 | 58.5 | 60.6 | 41.3 | 68.7 |
| | | (glass plate side) | | | | | | |
| | | Transmission chromaticity | x | 0.315 | 0.310 | 0.309 | 0.318 | 0.306 |
| | | (HC layer side) | y | 0.337 | 0.334 | 0.333 | 0.338 | 0.332 |
| | | Reflection chromaticity | x | 0.312 | 0.315 | 0.316 | 0.305 | 0.317 |
| | | (HC layer side) | y | 0.309 | 0.314 | 0.316 | 0.301 | 0.319 |
| | | Reflection chromaticity | x | 0.311 | 0.315 | 0.316 | 0.304 | 0.318 |
| | | (glass plate side) | y | 0.313 | 0.319 | 0.320 | 0.304 | 0.325 |
| | PET film | Luminous transmittance (%) | | 44.9 | 37.8 | 33.4 | 56.1 | 24.6 |
| | stack | Luminous reflectance (%) | | 47.7 | 55.1 | 58.3 | 37.0 | 66.1 |
| | (stacked | Transmission chromaticity | x | 0.345 | 0.343 | 0.344 | 0.345 | 0.343 |
| | film side) | | y | 0.361 | 0.360 | 0.360 | 0.358 | 0.361 |
| | | Reflection chromaticity | x | 0.283 | 0.291 | 0.294 | 0.268 | 0.301 |
| | | | y | 0.286 | 0.295 | 0.299 | 0.269 | 0.306 |

| | | | | | |
|---|---|---|---|---|---|
| Sheet resistance value ( Ω/sq) | 1.83 | 1.55 | 1.50 | 2.41 | 1.19 |

The half mirror front plate of the present invention, when installed on the front of a display, sufficiently functions as a mirror during the power off of the display and provides an image rarely different from the image before the installation thereof during the power on. The half mirror front plate of the present invention can be widely used in AV equipment and communication devices such as a television set, a personal computer, a car navigation system, a video camera, a tablet computer, a mobile phone and the like, and various monitors using a cathode-ray tube display, a liquid crystal display, a plasma display, an organic/inorganic EL display, an FED display and so on.

Several embodiments of the present invention are described, but it should be noted that these embodiments are only exemplary presentations and are not intended to limit the scope of the invention. These novel embodiments can be implemented in other various forms, and various omissions, substitutions, and changes can be made therein without departing from the spirit of the invention. These embodiments and their modifications are included in the scope and spirit of the invention and are also included in the scope of the inventions described in the claims and their equivalencies.

What is claimed is:

1. A half mirror front plate for display, comprising:
a stack consisting of a transparent substrate and a half mirror stacked film arranged on one principal surface of the transparent substrate,
wherein the half mirror stacked film has a first transparent oxide layer with a thickness of 45 nm to 70 nm made of a first metal oxide, a metal layer with a thickness of 30 nm to 45 nm mainly made of silver, and a second transparent oxide layer with a thickness of 45 nm to 70 nm made of a second metal oxide, in order from the transparent substrate side.

2. The half mirror front plate according to claim 1,
wherein the stack has a luminous transmittance by a C light source measured according to JIS Z8701 (1999) of 30% to 50% and a luminous reflectance of 40% to 60%.

3. The half mirror front plate according to claim 1,
wherein the metal layer contains 0.2 mass % to 10 mass % of gold and/or palladium to a total mass of constituent metals of the metal layer.

4. The half mirror front plate according to claim 1,
wherein both the first metal oxide and the second metal oxide contain, as a main component, a zinc oxide containing zinc as a main oxide constituent metal.

5. The half mirror front plate according to claim 4,
wherein the zinc oxide contains one or more selected from a group consisting of aluminum, titanium and gallium, as oxide constituent metals.

6. The half mirror front plate according to claim 1, further comprising:
a protective layer containing a tin oxide and/or an indium oxide as a main component on the half mirror stacked film.

7. The half mirror front plate according to claim 1,
wherein the transparent substrate is made of glass.

8. The half mirror front plate according to claim 1,
wherein the transparent substrate is made of resin, and the resin is polyester, cycloolefin polymer, polycarbonate, or triacetylcellulose.

9. The half mirror front plate according to claim 8, further comprising:
a hard coat layer on another principal surface of the transparent substrate.

10. The half mirror front plate according to claim 8, further comprising:
an adhesive layer on the half mirror stacked film.

11. The half mirror front plate according to claim 10, further comprising:
a glass plate on the adhesive layer.

12. The half mirror front plate according to claim 11,
wherein a luminous transmittance by a C light source measured according to JIS Z8701 (1999) is 25% to 50% and a luminous reflectance is 45% to 65%.
